(19) United States
(12) Patent Application Publication
(10) Pub. No.: US 2023/0177279 A1
(43) Pub. Date: Jun. 8, 2023

(54) System and Method for Training Language Models Using Already Trained Language Models

(71) Applicant: Cohere Inc., Toronto (CA)

(72) Inventors: Nicholas Myles Wisener FROSST, Toronto (CA); Rozhina GHANAVI, Toronto (CA); Christopher Alexander CREMER, Toronto (CA)

(73) Assignee: Cohere Inc., Toronto, ON (CA)

(21) Appl. No.: 18/060,341

(22) Filed: Nov. 30, 2022

Related U.S. Application Data
(60) Provisional application No. 63/285,516, filed on Dec. 3, 2021.

(51) Int. Cl. G06F 40/40; G06F 40/30; G06F 40/20

(52) U.S. Cl. CPC G06F 40/40; G06F 40/30; G06F 40/20

(57) ABSTRACT

The present disclosure relates to a system, method and non-transitory computer readable medium for training language models. The exemplary method includes obtaining a first language model. The method includes using a determined set of weights of the first language model to initialize a second language model. The first and second language model are different model types. The method includes applying the second language model to perform an operation.

### CROSS REFERENCE TO OTHER APPLICATIONS

This application claims priority to U.S. Provisional Patent Application No. 63/285,516 filed on Dec. 3, 2021, the entire contents of which is incorporated herein by reference.

### TECHNICAL FIELD

The following generally relates to training language models, in particular by initializing such models from already trained models, e.g., by training a representation model from a generation model.

### BACKGROUND

Progress in pre-trained large transformer-models [19] has enhanced the state-of-the-art (SOTA) in natural language processing (NLP). Transformer models for language can be divided into two general classes: generative and representational. These two model classes differ in their architectures and their training objectives, as well as their applications.

Generative language models are trained in an auto-regressive (AR) fashion from left to right. These models perform well at generating text [1], however their learned representations are often insufficient for downstream tasks. In contrast, representational models are optimized to embed text into useful representations.

With the constant increase of model sizes, training multiple models requires massive computing resources, and can be a lengthy process. In the literature, one solution to address problems associated with multiple models is to come up with a unifying model [7], [8]. The cost of having a unique model for both general sets of tasks is some performance loss across all the downstream applications. In [8], the authors reduced the performance loss only by making the model larger. Hence, there is a tradeoff between losing a model's downstream performance or spending twice the computing resources to train two models, one from each family of models.

It is an objective of the following to address at least one of the above-noted disadvantages.

### SUMMARY

Taking the above challenges into account, the present disclosure relates to a system, method, and computer readable medium (CRM) for training a language model based on an already trained language model. The present disclosure demonstrates that it is possible to preserve accuracy, and reduce compute time, when training both generative and representational models based on one another. In order to accelerate the training of at least one of the two models, it is shown herein that it is possible to transfer the knowledge between these families of models.

An objective is to reduce the computation cost while preserving the maximum performance across all tasks for a fixed number of parameters. To keep the performance at a high level, one needs both a generative and a representational model.

Advantageously, having access to large generative models one can speed up the training of representational models by initializing the training of the representational model with the weights of the generative model. That is, having a generative model, one can obtain a representational model at lower time and computational costs, with potential additional benefits such as reducing environmental impacts.

The present disclosure presents experimental results on downstream tasks and training losses to illustrate that this approach can assist with training faster and more responsibly across different model families and sizes, depending on the model size and family.

In one aspect, there is provided a method for training language models. The method includes obtaining a first language model, and using a determined set of weights of the first language model to initialize a second language model. The first and second language model are different model types. The method includes applying the second language model to perform an operation.

In example embodiments, the first language model is a generation model type and the second language model is a representational model type, or the first language model is a representation model and the second language model is a generation model.

In example embodiments, the first language model and the second language model are the same size.

In example embodiments, the second language model is trained further based on training samples relevant to the operation.

In example embodiments, initializing the second language model comprises duplicating the first language model, and updating an attention mechanism and a loss mechanism. The attention mechanism can be one of a unidirectional attention mechanism or a bi-directional attention mechanism. The loss mechanism can be one of an auto-regressive loss, a masked token loss, and a contrastive loss.

In example embodiments, the operation is one of paragraph completion, text classification, semantic textual similarity analysis, question answering, and sentiment analysis.

In example embodiments, the method further includes training the first language model, storing the first language model, and retrieving the first language model for use in initializing the second model.

In example embodiments, the method further includes transmitting the second language model to perform the operation.

In example embodiments, the method further includes storing the second language model, and retrieving the second language model for use in the operation.

In another aspect, a system for training language models is disclosed. The system includes a processor, a memory in communication with the processor. The memory includes computer executable instructions that when executed by the processor cause the processor to obtain a first language model. The memory causes the processor to use a determined set of weights of the first language model to initialize a second language model, the first and second language model being different model types. The memory causes the processor to apply the second language model to perform an operation.

In example embodiments, the first language model is a generation model type and the second language model is a representational model type, or the first language model is a representation model and the second language model is a generation model.

In example embodiments, the first language model and the second language model are the same size.

In example embodiments, the second language model is trained further based on training samples relevant to the operation.

In example embodiments, initializing the second language model comprises duplicating the first language model, and updating an attention mechanism and a loss mechanism. The attention mechanism can be one of a unidirectional attention mechanism or a bi-directional attention mechanism. The loss mechanism can be one of an auto-regressive loss, a masked token loss, and a contrastive loss.

In example embodiments, the operation is one of paragraph completion, text classification, semantic textual similarity analysis, question answering, and sentiment analysis.

In yet another aspect, a non-transitory computer readable medium for training a neural network model including a first plurality of nodes is disclosed. The computer readable medium includes computer executable instructions to obtain a first language model. The computer executable instructions are for using a determined set of weights of the first language model to initialize a second language model, the first and second language model being different model types. The computer executable instructions are for applying the second language model to perform an operation.

### BRIEF DESCRIPTION OF THE DRAWINGS

Embodiments will now be described with reference to the appended drawings wherein:

FIG. 1 is a block diagram of a computing environment in which a model training system is used.

FIGS. 2(a), 2(b) and 2(c) show cross entropy curves for AR2MLM and MLM for 124 Mil, 355 Mil, and 760 Mil model sizes respectively.

FIGS. 3(a), 3(b) and 3(c) show cross entropy curves for MLM2AR and AR for 124 Mil, 355 Mil, and 760 Mil model sizes respectively.

FIGS. 4(a), 4(b) and 4(c) show cross entropy curves for AR2Contrastive, MLM2Contrastive, and Contrastive for 124 Mil, 355 Mil, and 760 Mil model sizes respectively.

FIG. 5 is a uniformity and alignment graph.

### DETAILED DESCRIPTION

Language Models and Language Tasks

Important differentiating factors between different transformer-based language models are the types of attention used and the loss mechanisms employed. An attention matrix can be full or unidirectional. Models like GPT ([14], [15]) use auto-regressive left-to-right attention. A full (bidirectional) attention understands the relationships between all the words hence it is the most powerful approach for training representation models. As a result, all the masked language models (MLM) like BERT and all the contrastive approaches like DECLUTR and SimCSE ([6], [9], [10]) use full attention when training. Left-to-right attention is typically the preferred method to train for the generation tasks and full attention is typically preferred for natural language understanding tasks. Other works trying combinations of these approaches are listed in the following.

In ELMo [13], the authors use two unidirectional attentions, one left-to-right and one right-to-left, to train the model. For sequence-to-sequence [17] models, the tokens in the first part can attend to each other from both directions within the part, while the tokens of the second part can only attend to the left-to-right context in the second segment and itself plus the entire first segment. In UNILM [7], the authors change the pre-training objective between bidirectional, unidirectional and cross attention. The method used in UNILM only enabled the authors to reach the same performance across all tasks by utilizing larger model sizes. In GLM [8], the authors combine unidirectional and bidirectional attentions by letting unmasked tokens attending to the future tokens and masked tokens not being able to see the future tokens. This work also only reaches good performance across all tasks by increasing the model size. No model is known that has enabled reaching to the SOTA performance in all the tasks by training only one model.

Loss functions can be grouped into AR losses, masked token losses, and contrastive losses. AR losses [14], [1] measures the probability of computing the correct future tokens conditioned on all the previous ones. Masked token losses [6] computes the probability of predicting the unseen tokens given all the other tokens. Contrastive losses [4], [10], [9] for pairs of similar samples (positive pairs) and pairs of unrelated samples (negative samples) measure the probability of positive pairs embedding being closer to each other's and negative ones being farther apart.

Naturally, a model with left-to-right attention can use an AR loss and a model with bidirectional attention can use an MLM loss [6], a contrastive loss, or a combination of both [10], [9].

Language tasks can be categorized into two major groups, generation (or generative) and representation (or representational) tasks.

The first category of tasks is language generation related problems. Examples of this group is paragraph completion, classification, etc. Academic benchmarks to measure generation tasks quality are, LAMBADA [12], LM1B [3], and HellaSwag [22]. For this group of tasks one is predicting the future, hence AR models are considered the best models.

The second category of language problems is representation tasks. This group of tasks is also referred to as natural language understanding (NLU) and examples of this group are semantic textual similarity (STS) [2], question answering [16], sentiment analysis [18], etc. Examples of benchmarks for evaluating representational models' performance are as follows. With General Language Understanding Evaluation (GLUE) [20], this benchmark is a collection of nine language understanding tasks, e.g., question answering, STS, sentiment analysis, etc. Another example is SuperGLUE [21] that includes eight tasks such as question answering. The last benchmark considered herein is SentEval [5]. This benchmark provides a framework for evaluating raw embeddings as well as finetuned embeddings on various embeddings tasks including, STS, classification, etc. Capturing the essence of a language requires a bidirectional understanding of it, hence for this group of tasks, masked language models and contrastive methods are found to outperform AR methods.

As noted above, the first category of tasks is language generation related problems. For generation tasks, AR models are a natural best choice for finding the next tokens. On the other hand, for representation tasks, since relations between all the words need to be known, bidirectional approaches with losses or contrastive losses result in better performance. This means that in order to gain the best performance across all tasks there is a need to train at least two models for each model size. This would appear to necessitate at least a two-fold dedication of compute and time resources.

To address this problem, herein proposed is an approach to transfer learning from one model to another to train the other model faster. It is shown that initializing some language models with certain other trained language models of the same size reduces the needed training time.

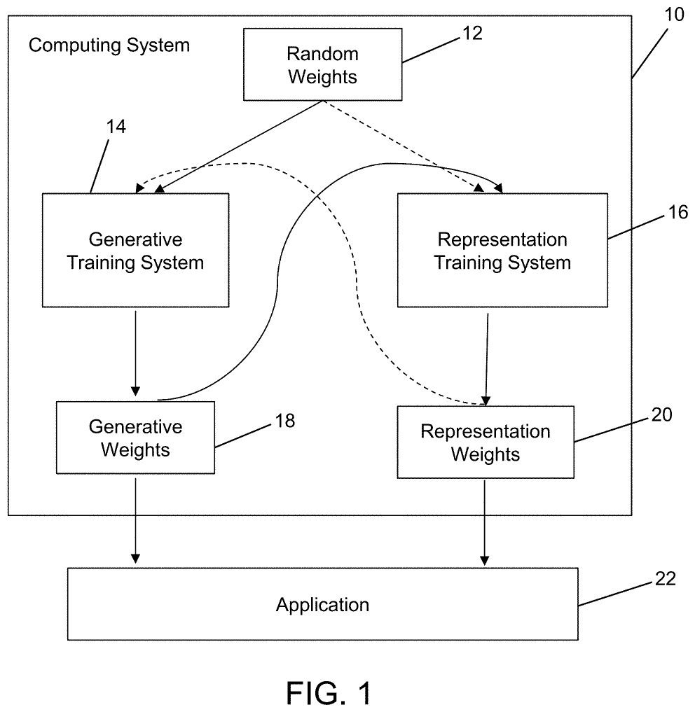

Referring now to the figures, FIG. 1 illustrates an example of a computing environment in which a computing system 10 (e.g., a model training system) is used to leverage weights from a first model to generate a second model to be used in an application 22. The computing system 10 includes a generative training system 14 and a representation training system 16 that can each use random weights 12 to generate generative weights 18 or representation weights 20 respectively, for the first model, to be used to generate the second model with less effort, cost, etc. as discussed herein. In this way, both a trained generative model and a trained representation model can be obtained with reduced time, cost, compute power, environmental impact, etc.

In the solution presented herein, the following cases have been considered: using a trained AR model (GPT) to train a masked language model (MLM), using a trained AR model (GPT) to train a contrastive model (DECLUTR), using an MLM model to train an AR model (GPT), using an MLM model to train a contrastive model (DECLUTR).

### Algorithm

As mentioned above, to get the SOTA performance across all language tasks, one needs to at least train two models from different families of the same size. Training multiple language models from scratch can be considered wasteful to time and computational resources and is not environmentally friendly. To increase the speed and reduce the potential environmental harm caused by training large language models, the present method proposes transferring knowledge across language models for training faster and more responsibly. As an example, this can mean in case someone has access to a trained AR model and would like to train an MLM model of the same size they should initialize the MLM model with the AR model weights (as illustrated in FIG. 1) and update the loss and attention. Empirically it can be shown that this result holds for all the language models having been tested, and these models are better to be initialized with another fully trained language model.

### EXPERIMENTS

In this section, an experimental setup and its results are presented. Three different model types have been trained from scratch, namely AR (GPT), MLM, and contrastive (DECLUTR). All of these models are trained with AdamW [11] optimizer with β1=0.9, β2=0.98 and ε=1e−6. One can use a linear warm-up learning rate over 10% of the steps and a linear decay afterward. The max learning rate is 5e−5. The generative models are trained on Coheretext data—a proprietary data set composed of web scrapes and curated English text datasets. MLM models are trained on Masked Coheretext, the same data set but where 15% of the data is masked. The masking process is as follows, 80% are replaced by [MASK] tokens, 13% are replaced by random tokens and the other 7% of tokens remain unchanged. For contrastive models, using Coheretext, an anchor is sampled from each document, as is a positive sample that is either adjacent, overlapping, or subsumed by anchor. Then, sample one hard negative sequence from somewhere else in the same document. All the other examples in the batch are used as negative samples as well. One can train the models on Google V3 TPUs. For all the experiments three different model sizes were considered, namely 128 million parameters (Mil), 355 Mil, and 760 Mil. In the present analysis, special interest is given to using large existing AR models to train representational language models. To this end, most of the results are focused on using an AR model to train a representational model. To show that the present method is not only limited to train faster representational models, below some results are provided for using an MLM model to train an AR model.

### AR to MLM

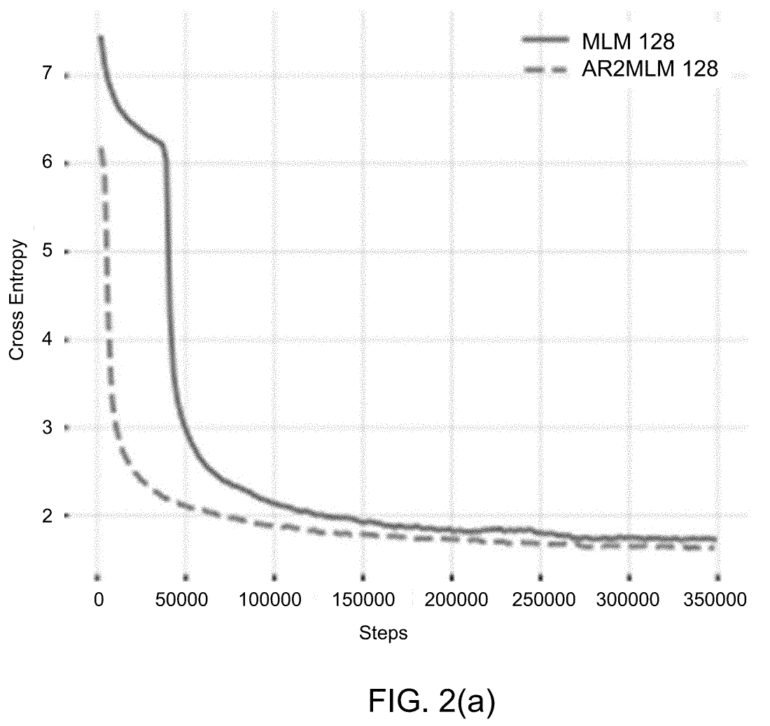

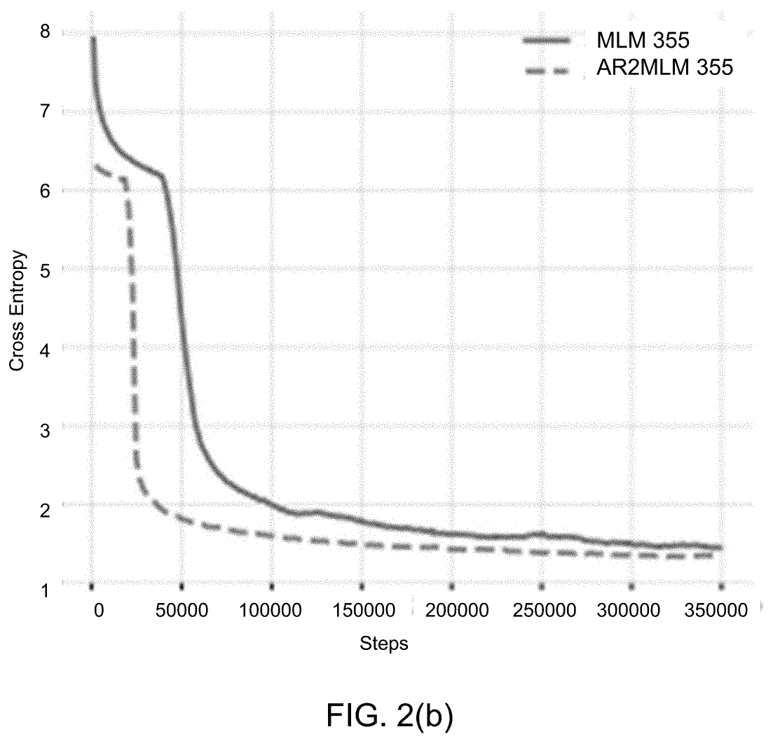

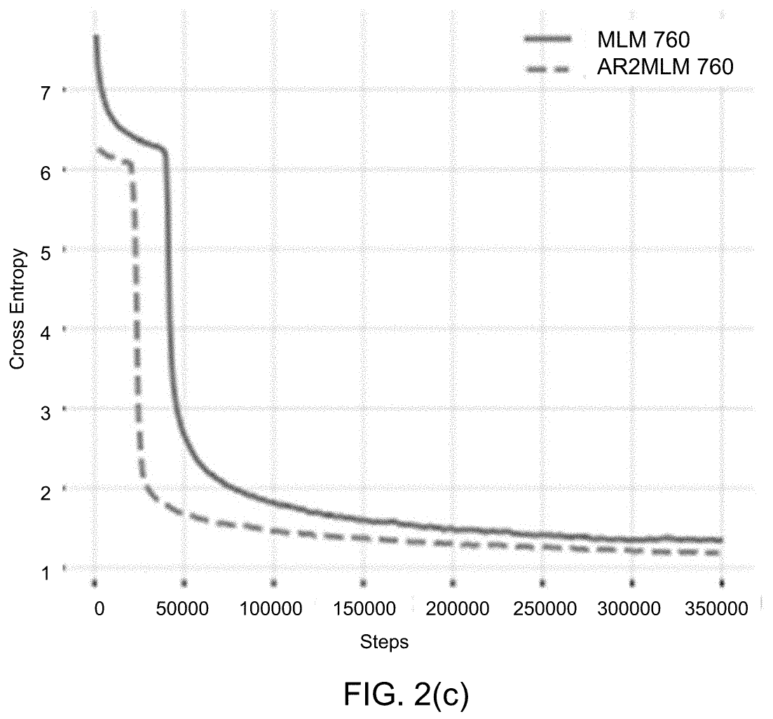

In this section an MLM performance when trained with the present transfer learning proposal is compared with training from scratch. The transfer learning in this section is from an AR model (GPT) to an MLM model and can be referred to as “AR2MLM”. FIG. 2 presents the validation loss of this comparison for different model sizes. These experiments show that across different model sizes training an MLM model from a pretrained GPT rather than from random initialization results in training faster. For measuring speedups for these experiments, the following approach can be taken. First, read the final cross entropy value for the model trained from the random initialization. Then, count how many steps it takes for the model initialized from a pretrained model to reach that cross entropy. Lastly, the ratio between the number of steps for the model from scratch and the model using a pretrained initialization is reported as speedup. In Table 1, below the speedup gained from using pretrained models is quantified.

TABLE 1
Performance improvement using BOGO.

| Model | 128 Mil | 355 Mil | 760 Mil |
|---|---|---|---|
| AR2MLM vs. MLM | 1.93X | 1.86X | 2.15X |
| MLM2AR vs. AR | 2.47X | 1.31X | 1.93X |
| AR2Contrastive vs Contrastive | 5.8X | 7.2X | 15.33X |
| MLM2Contrastive vs Constrastive | 7.1X | 6.7X | 15.40X |

### MLM to AR

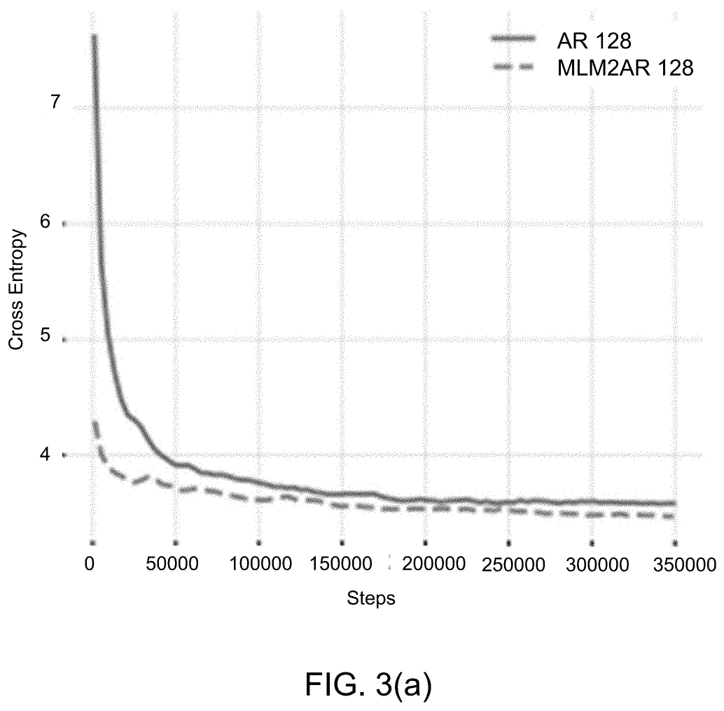

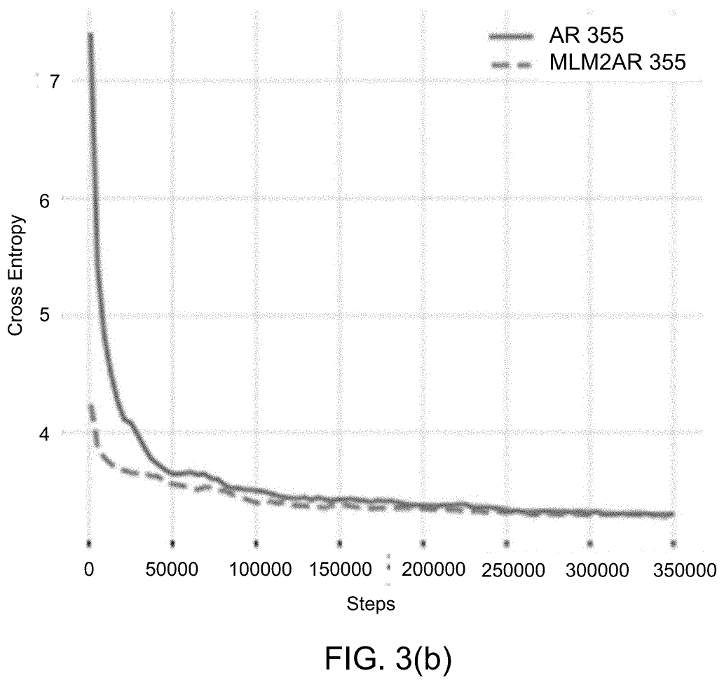

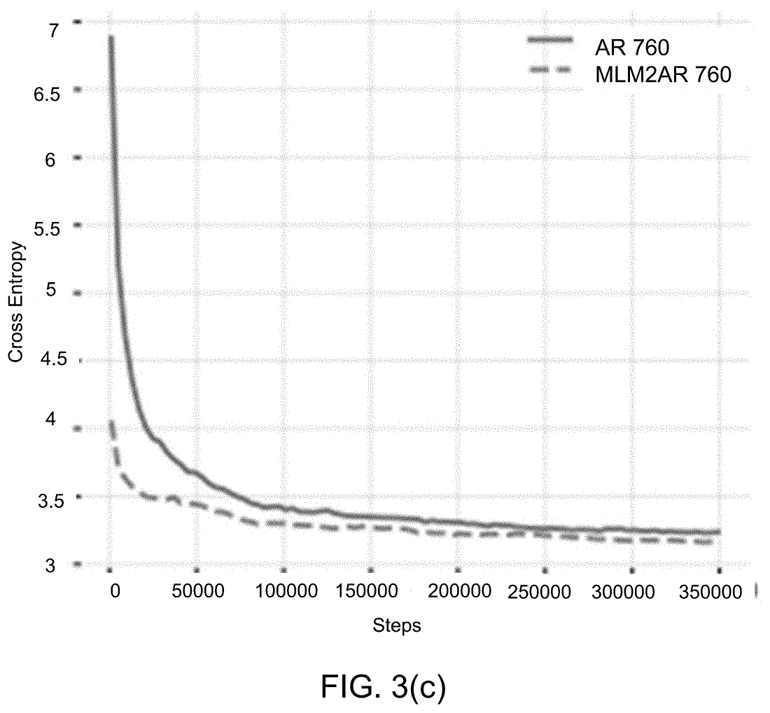

In this section AR model performance when initialized with an MLM model and trained by the transfer learning proposal is compared with training an AR model from scratch. FIG. 3 presents the LAMBADA [12] results for this comparison. From this experiment it is apparent that training an AR model from scratch always performs worse compared to initializing the same AR model from an MLM model. Similar to the approach used above, this performance is quantified in Table 1 above.

### Transferring to Contrastive Loss

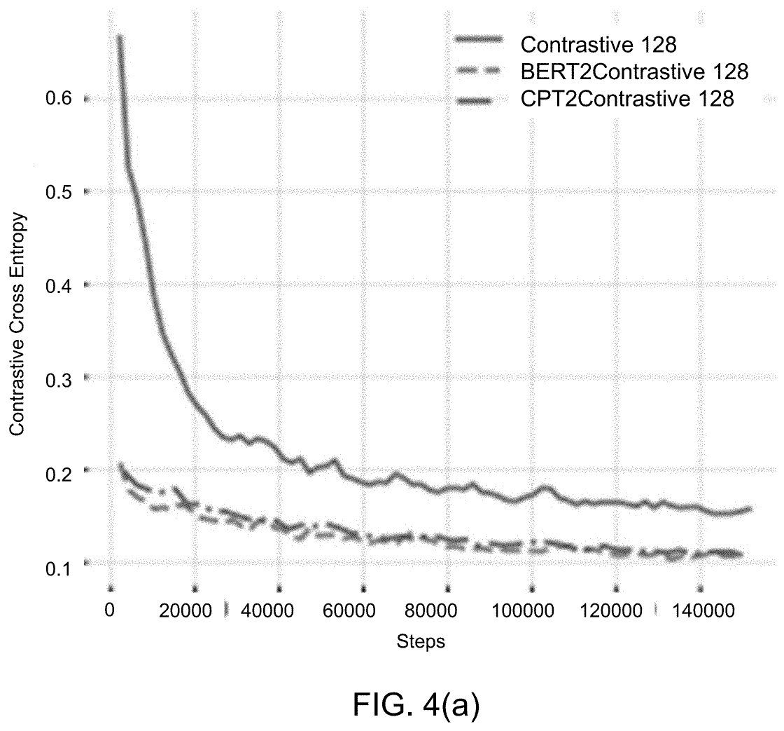

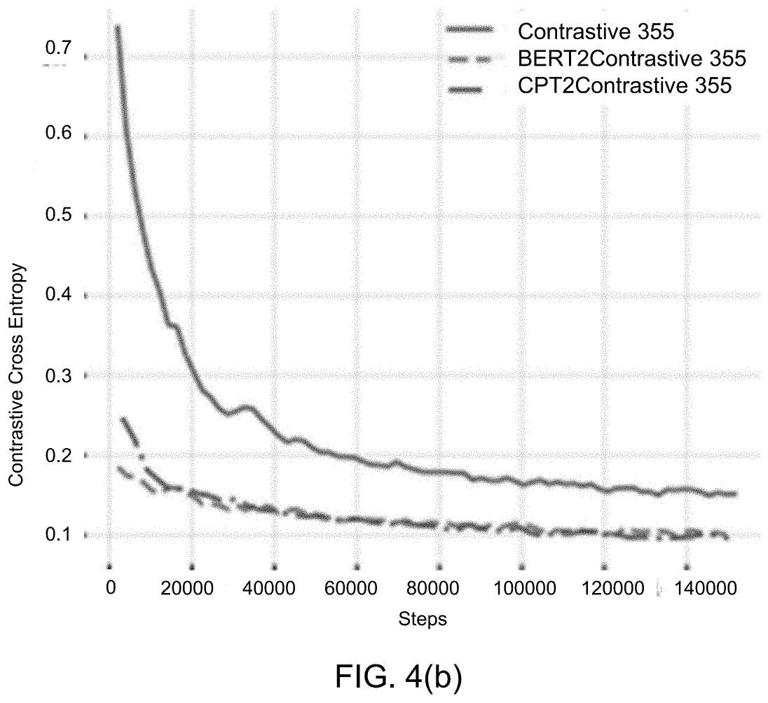

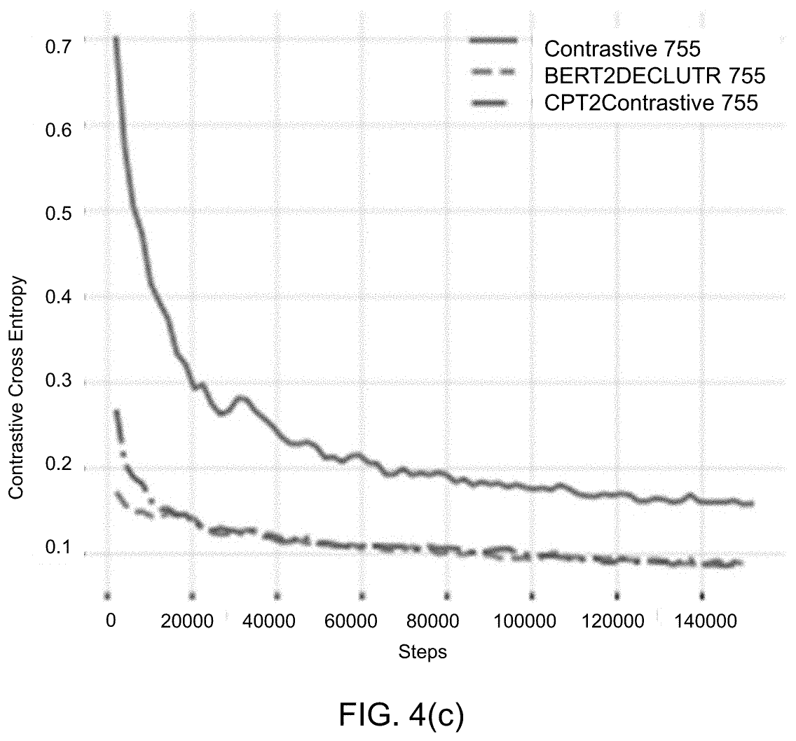

A contrastive loss model performance when initialized from a trained language model is compared to when it starts from scratch. For the pretrained language model, the following two cases are considered, namely an AR model (GPT) and an MLM model, called AR2Contrastive and MLM2Contrastive respectively. FIG. 4 presents the validation set contrastive cross entropy loss for all the aforementioned 3 methods across 3 different model sizes. From these results it can be observed that initializing the contrastive loss from GPT or MLM always results in a lower cross entropy and converges to a better loss faster than initializing from scratch. It is also notable that contrastive cross entropy for starting from either GPT and MLM is quite similar. The optimization loss in here is the same as [10], which is MLM cross entropy plus contrastive cross entropy which is herein referred to as Contrasitve-MLM loss. Similar to the approach used in the previous section this performance is quantified in Table

### Uniformity and Alignment Analysis

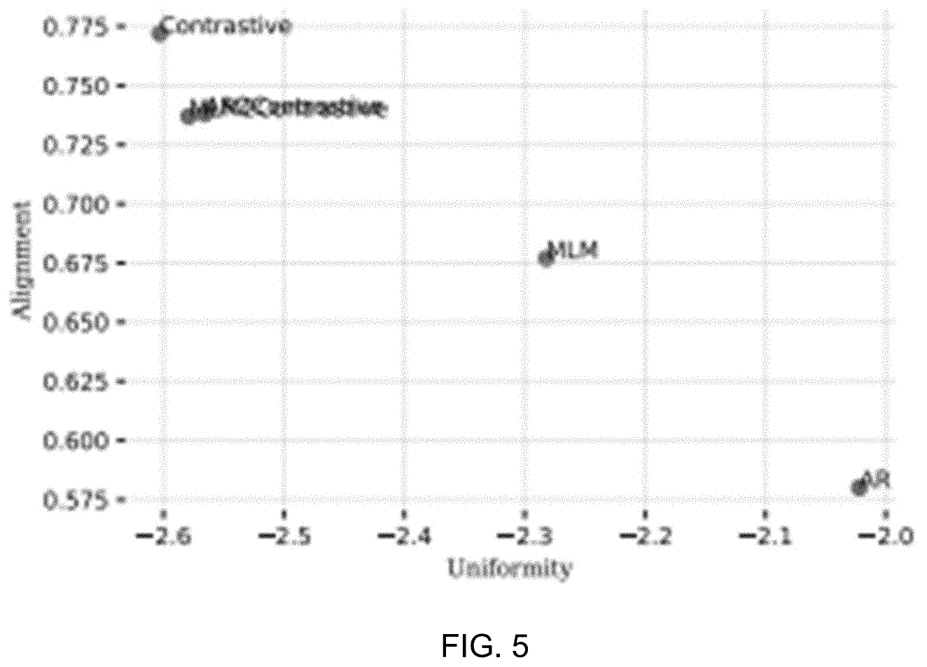

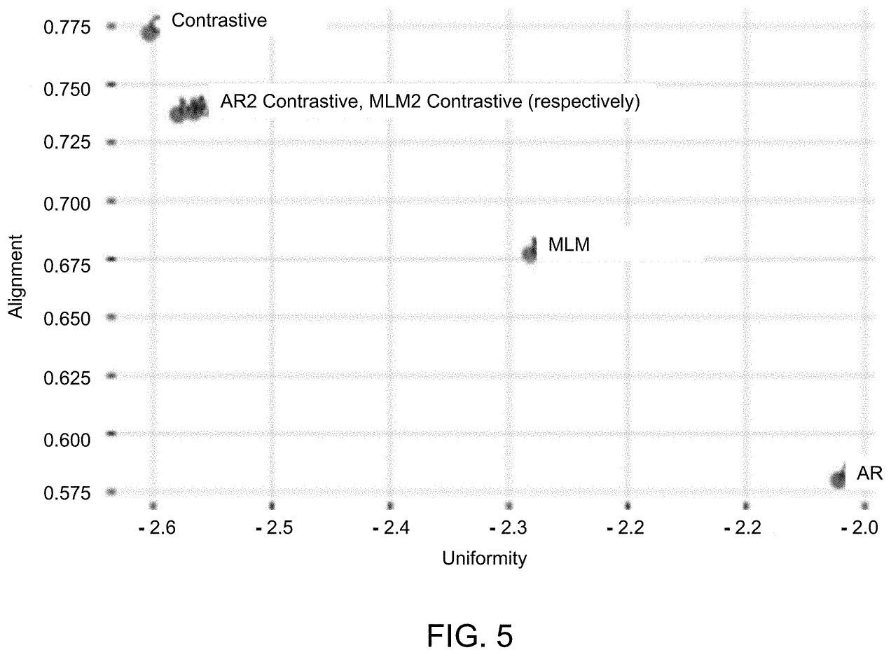

In FIG. 5, the alignment and uniformity metric of AR, AR2Contrastive, MLM, MLM2Contrastive, and Contrastive are visualized, all 760 Mil for STS-B benchmark. In this analysis for both alignment and uniformity, lower numbers are better. As shown in FIG. 5, AR models have the worst uniformity and the best alignment and as the models are trained on a contrastive loss, on an AR model uniformity gets better. On an MLM loss also as the models are trained on a contrastive loss the uniformity gets better. It is notable that the results for both MLM2Contrastive and AR2Contrastive are very close to each other and also somewhat close to the Contrastive model trained from scratch.

### Downstream Performance of Representation Models

The results for the downstream tasks are now discussed. Here, one can use SentEval and set it up as in [5]. This benchmark measures the quality of both raw and finetuned embeddings and gives a better understanding of how good the general embeddings are compared to the other benchmarks. Table 2 below presents these results. From this table one can see that initializing a contrastive loss from a pretrained model, either MLM or AR, improves the results across all the model sizes. It is also notable that as the model size increases, this improvement becomes more promising. Since for larger models, more compute and resources are being used, initializing them from a pretrained model becomes more important to train faster and more responsibly.

TABLE 2
Downstream tasks performance on SentEval embedding tasks.

| Model (size) | STS12 | STS13 | STS14 | STS15 | STS16 | STSb | SICK-R | MR | CR | SUBJ | MPQA |
|---|---|---|---|---|---|---|---|---|---|---|---|
| Contrastive (760) | 0.5945 | 0.6117 | 0.6461 | 0.7284 | 0.7072 | 0.6380 | 0.3885 | 0.7300 | 0.7801 | 0.9108 | 0.8159 |
| MLM2Contrastive (760) | 0.6104 | 0.6615 | 0.6496 | 0.7400 | 0.7589 | 0.6637 | 0.7274 | 0.8224 | 0.8834 | 0.9517 | 0.8598 |
| AR2Contrastive (760) | 0.6120 | 0.6612 | 0.6635 | 0.7546 | 0.7512 | 0.6650 | 0.7126 | 0.8163 | 0.8898 | 0.9531 | 0.8654 |
| AR (760) | 0.5078 | 0.4626 | 0.5041 | 0.6108 | 0.5383 | 0.4559 | 0.6639 | 0.8009 | 0.8599 | 0.94 | 0.8676 |
| MLM (760) | 0.5349 | 0.5439 | 0.5815 | 0.6834 | 0.6537 | 0.5062 | 0.7063 | 0.8087 | 0.8755 | 0.9473 | 0.8389 |
| Contrastive (355) | 0.5988 | 0.6207 | 0.6467 | 0.7329 | 0.7208 | 0.644 | 0.6591 | 0.7252 | 0.7947 | 0.9108 | 0.8213 |
| MLM2Constrastive (355) | 0.6002 | 0.6463 | 0.6494 | 0.7392 | 0.7521 | 0.6133 | 0.7024 | 0.7884 | 0.8607 | 0.9455 | 0.836 |
| AR2Contrastive (355) | 0.61 | 0.6496 | 0.6537 | 0.7479 | 0.7472 | 0.6459 | 0.7527 | 0.8008 | 0.8726 | 0.9476 | 0.8555 |
| Contrastive (124) | 0.5975 | 0.624 | 0.6499 | 0.7312 | 0.7082 | 0.644 | 0.5378 | 0.7348 | 0.7899 | 0.9079 | 0.8195 |
| MLM2Contrastive (124) | 0.604 | 0.6223 | 0.6547 | 0.7369 | 0.7452 | 0.633 | 0.6431 | 0.7639 | 0.8291 | 0.9316 | 0.8388 |
| AR2Contrastive (124) | 0.6104 | 0.6403 | 0.6606 | 0.7335 | 0.7340 | 0.6447 | 0.6497 | 0.7644 | 0.8106 | 0.9296 | 0.8352 |

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape or other compute resources such as CPUs, GPUs, TPUs, etc. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both, including cloud-based storage solutions using any of the above or other technologies. Any such computer storage media may be part of the training system 10 or application 14, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of training language models, the method comprising:
obtain a first language model;
using a determined set of weights of the first language model to initialize a second language model, the first and second language model being different model types; and
applying the second language model to perform an operation.

2. The method of claim 1, wherein the first language model is a generation model type and the second language model is a representational model type, or the first language model is a representation model and the second language model is a generation model.

3. The method of claim 1, wherein the first language model and the second language model are the same size.

4. The method of claim 1, wherein the second language model is trained further based on training samples relevant to the operation.

5. The method of claim 1, wherein initializing the second language model comprises duplicating the first language model, and updating an attention mechanism and a loss mechanism.

6. The method of claim 5, wherein the attention mechanism is one of a unidirectional attention mechanism or a bi-directional attention mechanism.

7. The method of claim 5, wherein the loss mechanism is one of an auto-regressive loss, a masked token loss, and a contrastive loss.

8. The method of claim 1, wherein the operation is one of paragraph completion, text classification, semantic textual similarity analysis, question answering, and sentiment analysis.

9. The method of claim 1, further comprising training the first language model, storing the first language model, and retrieving the first language model for use in initializing the second model.

10. The method of claim 1, further comprising transmitting the second language model to perform the operation.

11. The method of claim 1, further comprising:
storing the second language model; and
retrieving the second language model for use in the operation.

12. A system for training language models, the system comprising:
a processor;
a memory in communication with the processor, the memory comprising computer executable instructions that when executed by the processor cause the processor to:
obtain a first language model;
use a determined set of weights of the first language model to initialize a second language model, the first and second language model being different model types; and
apply the second language model to perform an operation.

13. The system of claim 12, wherein the first language model is a generation model type and the second language model is a representational model type, or the first language model is a representation model and the second language model is a generation model.

14. The system of claim 12, wherein the first language model and the second language model are the same size.

15. The system of claim 12, wherein the second language model is trained further based on training samples relevant to the operation.

16. The system of claim 12, wherein initializing the second language model comprises duplicating the first language model, and updating an attention mechanism and a loss mechanism.

17. The system of claim 16, wherein the attention mechanism is one of a unidirectional attention mechanism or a bi-directional attention mechanism.

18. The system of claim 16, wherein the loss mechanism is one of an auto-regressive loss, a masked token loss, and a contrastive loss.

19. The system of claim 12, the operation is one of paragraph completion, text classification, semantic textual similarity analysis, question answering, and sentiment analysis.

20. A non-transitory computer readable medium for training a neural network model including a first plurality of nodes, the computer readable medium comprising computer executable instructions to:
obtain a first language model;
use a determined set of weights of the first language model to initialize a second language model, the first and second language model being different model types; and
apply the second language model to perform an operation.
